(19) United States
(12) Patent Application Publication
(10) Pub. No.: US 2007/0080585 A1
(43) Pub. Date: Apr. 12, 2007

(54) Incorporated wide-angle rearview mirror for rearview and reverse surveillance

(76) Inventor: Cing-Liang Lyu, Pingtung County (TW)

Correspondence Address: LYU, CING LIANG, P.O. Box 44 - 2049, Taipei, 10668, TW

(21) Appl. No.: 11/286,325

(22) Filed: Nov. 25, 2005

(30) Foreign Application Priority Data
Oct. 12, 2005 (TW) 094217594

(51) Int. Cl. B60L 1/00

(52) U.S. Cl. 307/10.1

(57) ABSTRACT

This invention presented is an incorporated wide-angle rearview mirror for rearview and reverse surveillance, composed of a wide-angle rearview mirror, a LCD monitor invisibly installed inside said wide-angle rearview mirror with a light resistance set inside the LCD monitor, a vehicle rearview CCTV system, an incorporated printed circuit board, a reversing light circuit and a vehicle gear. When a driver is backing his/her ca, the reversing light circuit supplies power to simultaneously switch on the camera and monitor circuits, thereby enabling the wide-angle rearview mirror and the monitor to display images behind the vehicle for monitoring the situations below the vehicle rearview, in addition, the LCD monitor is able to adjust the brightness corresponding to ambient light.

### BACKGROUND OF THE INVENTION

(1.) Field of the Invention

This invention relates to a LCD monitor with a light resistance invisibly disposed in a vehicle interior wide-angle rearview mirror, in particular, to a rearview mirror technology for simultaneously driving and stopping a vehicle rearview CCTV system and said LCD monitor, at the same time, showing images in the rearview mirror and in the camera mounted below the vehicle rearview by a reversing light power source.

(2.) Description of the Prior Art

A conventional vehicle interior wide-angle rearview mirror (hereafter wide-angle rearview mirror) with a miniature LCD monitor (hereafter monitor) installed therein is designed based on the technology concept of broadcasting TV or DVD programs as a form of in-car recreation on a monitor, which is mainly used to display images transmitted by a camera mounted below the vehicle rearview, excepting the time period of driving a car in reverse; consequently, such a design results in the following drawbacks.

1. The electricity has to be supplied by the main power source of a vehicle for driving the monitor at any time.

2. The vehicle power source has to be manually switched on; therefore, the power source must be frequently switched on and off, in the event the time and the number of times for watching TV or DVD programs in car are more often than backing a car.

3. If the monitor is switched on while a driver is backing a car, it needs the driver to wait for about 3˜5 seconds for showing captions or subtitles on the monitor; therefore, an impatient driver useally gives up using such a vehicle rearview and reverse surveillance, making the camera installed in vain.

4. When a driver desires to back his/her car and switch on the camera and the one showing images behind his/her vehicle rearview at the same time s/he is watching a DVD program, an elaborate automatic switching circuit must be installed inside the vehicle video system to enabling the function, however, such circuit installation may possibly affect the original vehicle video relevant circuits, so as to reduce the quality.

5. It is very often that a driver forgets to switch off the vehicle power source after the monitor is switched on; therefore, when the driver starts the vehicle next time, the monitor is damaged due to the impact of a sudden voltage and current rise.

6. The monitor size of a conventional vehicle rearview mirror is 2.5″, not suitable for people to watch in-car DVD programs, in view of video specification and quality. Besides, a variety of vehicle types have been equipped with their specific in-car video devices, so that such an in-car monitor is superfluous to be installed in a vehicle.

7. The monitor size of a conventional vehicle rearview mirror is located on the upper right corner of a driver (when the driver's seat is on the left), if the driver is watching a program during driving, such kind of behavior definitely affects driving safety without doubt.

8. With an increasing technology of equipping a sedan or a recreational vehicle (RV) with an audio/video equipment inside thereof, a monitor becomes an in-car standard equipment. However, for the sake of driving safety, a monitor installed around a vehicle motor control panel has been under the governmental regulations that those TV or DVD programs must be played when a vehicle hand brake is pulled on, excepting for displaying satellite positioning.

9. Said motor control panel monitor is able to be used to display all kinds of vehicle surveillane images as it should be, however, if said monitor is used for vehicle reverse surveillance, the distance between said monitor and the rearview mirror installed on the upper right side of a driver is approximately half a meter, so as to make the driver difficult to look from both sides. In addition, how to start a vehicle rearview CCTV system when a car is in reverse gear and how to stop play programs on said monitor to display images of vehicle rearview camera need complicated switching circuits to be designed.

10. There are huge differences between the vehicle streams of light during various stituations, such as daytime against dark night, indoor against outdoor, or on the road against inside a tunnel, therefore, if said monitor retains the same illumination during different situations, such a monitor is not suitable for being used for proper functions, moreover, if a driver manually adjusts the monitor illumination when backing a car, such act may cause the danger to the driver.

Furthermore, a lengthened (wide-angle) vehicle rearview mirror has been in use in Asia long before a LCD monitor is on the market. However, the installation method is to clip said mirror to the original rearview mirror inside a vehicle, excepting for those tailor-made mirrors for a variety of vehicle types. In addition, those drivers are used to look images in their vehicle rearview mirrors for reference.

In summary, the invention is disclosed herein to improve the drawbacks of a conventional technology.

### SUMMARY OF THE INVENTION

Therefore, to solve the afore-mentioned problems of conventional vehicle rearview and reverse surveillance system, the main objective of the invention is to provide a rearview mirror technology for simultaneously supplying electricity to a vehicle rearview CCTV system and its LCD monitor (hereafter referred to as a reverse surveillance function or system), at the same time, showing images in the rearview mirror and in the rearview CCTV system for clearly and truly monitoring the statuses on the back and below the vehicle rearview, as long as a driver reverses gear to back a car. The power supply is cut off when the vehicle is not in reverse gear position, so as to restore the automatic functions of the wide-angle rearview mirror.

The most characteristic of the invention lies in that a conventional monitor for reverse surveillance is no longer used for concurrently playing TV, DVD or GPS programs; instead, the monitor concentrates on displaying and monitoring all images below the vehicle rearview when a driver is backing the vehicle.

Another objective of the invention is to provide a breakthrough notion of a vehicle that the power source used for rearview and reverse surveillance system comes from a reversing light circuit, so that the switch-on or off of the reversing light enables the supply of a halt of the power source.

The invention concentrates on providing a simplified and safety reverse gear mechanism with the the functions of automation, less failure and lower costs.

In addition, the invention enables the monitor of said reverse surveillance system to respond to varied brightness of different environments to automatically adjust the illumination for a driver to clear watch displayed images.

To achieve the afore-mentioned objectives, the invention is composed of a wide-angle rearview mirror, a monitor invisibly installed inside said wide-angle rearview mirror, a vehicle rearview camera installed on the back of a vehicle, a power source cable and a signal cable installed between said monitor and said camera, an incorporated power source and signal printed circuit board, a reversing light circuit for supply electricity to the power source and a vehicle gear.

To truly reflect the function of a wide-angle rearview mirror, said mirror is designed as a slight convex surface. To enable images in said monitor, which is invisibly disposed on the back of the rearview mirror, to be through, the mirror corresponding to the display lens is a single-sided driving mirror; therefore, said mirror is a reflector when there is no any image displayed in the monitor, whereas part of said mirror becomes a transparent-like glass when there is an image displayed in the monitor. Consequently, when the monitor does not show any image therein without the driver movement of backing a vehicle, the rearview mirror performs as a wide-angle rearview mirror; on the contrary, when a driver is backing a car, said wide-angle rearview mirror has one small part thereof to enable the monitor to see through the images below the vehicle rearview. The invention adopts a wide-angle rearview mirror for the reason that the kind of mirror enables sufficient width to contain the monitor. Actually, the design of combining said rearview mirror with said monitor is able to be diversified. In addition, the best material of a wide-angle rearview mirror is an anti-glare lens.

Said monitor is invisibly installed on the left back of a wide-angle rearview mirror (in the event the driver's seat is on the right, the monitor is installed on the right side), so that a driver is able to easily watch images displayed therein; nevertheless, a field of mirror on the left has to be appropriately reserved in order to retain sufficient eyesight view in the rearview mirror when a driver is back a car. Said monitor is set to display images at once as long as the power is supplied without any prior commercial captions or statements played.

Seeing that said surveillance camera installed on the vehicle rearview for monitoring reverse gear monitoring is unable to reflect in the rearview mirror the conditions on the dead space below the vehicle rearview, the mirror has to be positioned based on real requirement and the shape of a vehicle back, in addition to the function to immediately display images soon after the power supply.

To enable the light intensity, colors, hues of the monitor disclosed in the invention to accommodate varied streams of light from the environment, a light resistance is able to be set between the monitor and an power source and signal incorporated printed circuit board to enable the photosensitive function to adjust the light intensity, colors and hues of the monitor.

The most characteristic of the invention lies in that the specific function of an incorporated wide-angle rearview mirror for rearview and reverse surveillance enables the integrated power source to supply electricity by using a reversing light circuit, therefore, when a driver is backing a car and the gear is in reverse position, said power of said reverse surveillance system is simultaneously switched on for the system to transmit signals; whereas the power supply of the reversing light is cut off when the gear is not in the reverse position and the power supply and signal circuit of the invention are switched off at the same time.

A power source and signal incorporated printed circuit board must be set between the reverse surveillance system and the reversing light circuit for supply power, in addition, the most appropriate position of said power source and signal incorporated printed circuit board is on the back of a wide-angle rearview mirror near the monitor.

As described above, said wide-angle rearview mirror of the invention is a general vehicle rearview mirror when a driver is not backing the car; nevertheless, when a driver is backing the car and makes the gear in the reverse position, the reversing light is power supplied to enable a part of the power to flow through the power source and signal incorporated printed circuit board to switch on the power of the reverse surveillance system, in addition, the monitor, which is invisibly installed inside the wide-angle rearview mirror, reflect images through a one-way window of the rearview mirror, owing to its high brightness, consequently, the wide-angle rearview mirror is a rearview mirror and displays images below the vehicle rearview captured by the camera through the power source and signal incorporated printed circuit for a driver to watch in the small window of the monitor. Therefore, the invention is a driving safety device providing a driver with the most automatic and exactest rearview surveillance on the dead space below the vehicle rearview.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a perspective view showing a wide-angle rearview mirror of the invention; and

FIG. 2 is a perspective view of a power supply and signal circuit according to the invention.

### DETAILED DESCRIPTION OF THE PREFERRED EMBODIMENTS

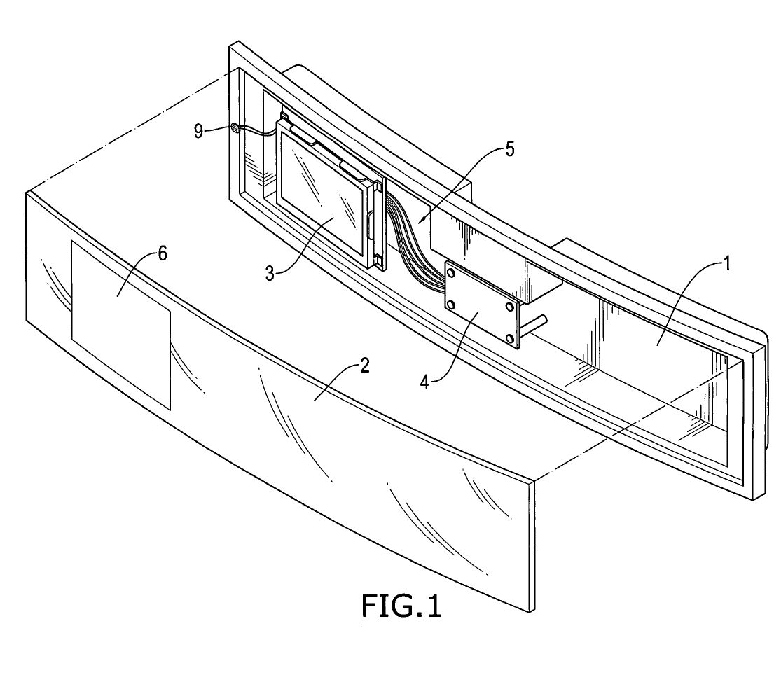

With the reference to a perspective view showing a wide-angle rearview mirror of the invention in FIG. 1, a mirror stand 1 is slight convex for covering and inlaying a curved rearview lens 2 on th front thereof for more wider-angle. Said mirror stand 1 has a monitor 3 invisibly installed inside thereof and has a power source and signal incorporated printed circuit board 4 contained therein. A power supply and signal circuit 5 is set between said monitor 3 and said power source and signal incorporated printed circuit board 4 for connecting both. The power source and signal incorporated printed circuit board 4 has a power supply and signal circuit connect to a reversing light circuit and a vehicle rearview CCTV system (not shown). The lens 2 is an anti-glare lens with a slight convex surface, excepting for a part of the lens to be a single-sided driving mirror (single-surface glass) corresponding to a display window 6. A light resistance is set inside the mirror stand 1 for appropriately reflecting ambient light near the body of the monitor 3.

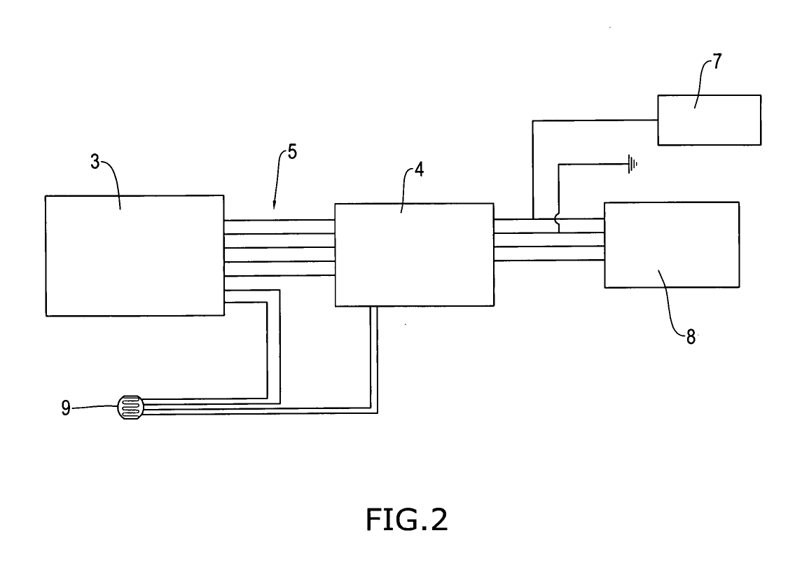

With reference to the perspective view showing the power supply and signal circuit in FIG. 2, the power is supplied by a reversing light circuit 7, the power source and the signal set between the monitor 3 and a vehicle rearview camera 8 are integrated and controlled by the power source and signal incorporated printed circuit board 4. A light resistance 9 is set between the monitor 3 and the power source and signal incorporated printed circuit board 4 for automatically adjusting light intensity, colors and hues of the monitor 3.

Therefore, as long as a driver puts the vehicle gear in the reverse position, the monitor on said wide-angle rearview mirror automatically displays the situations below the vehicle rearview, at the same time, enables a driver to watch the situations behine the vehicle via the rearview mirror. When the gear is not in the reverse position, the camera and the monitor is automatically switched off enabling the original functions of said wide-angle rearview mirror to be restored.

New characteristics and advantages of the invention covered by this document have been set forth in the foregoing description. It is to be expressly understood however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course defined in the language in which the appended claims are expressed.

What is claimed is:

1. An incorporated wide-angle rearview mirror for rearview and reverse surveillance is composed of a wide-angle rearview mirror, a LCD monitor invisibly installed inside said wide-angle rearview mirror, a power source cable and a signal cable installed inside said wide-angle rearview mirror, a reversing light circuit for supply electricity to the power source, a vehicle gear and a vehicle rearview CCTV system; the characteristic lies in: the power of said vehicle rearview CCTV system and said LCD monitor are supplied by the reversing light circuit and switched on or off by the vehicle gear.

2. The incorporated wide-angle rearview mirror of claim 1, wherein the vehicle rearview CCTV camera, the LCD monitor and the reversing light circuit enable the power and signal transmitted in-between to be integrated and controlled by the power source and signal incorporated printed circuit board.

3. The incorporated wide-angle rearview mirror of claim 1, wherein the vehicle rearview CCTV system and LCD monitor are switched on or off depending on whether the vehicle gear is in the reverse position.

4. The incorporated wide-angle rearview mirror of claim 1, wherein the monitor has a light resistance set therein for appropriately reflecting ambient light and adjusting the brightness of the monitor.

5. The incorporated wide-angle rearview mirror of claim 1, wherein the wide-angle rearview mirror is an anti-glare lens with a shift convex surface and a part of the lens is a single-sided driving mirror corresponding to a display window of the LCD monitor.
